(19) United States
(12) Patent Application Publication
(10) Pub. No.: US 2017/0254685 A1
(43) Pub. Date: Sep. 7, 2017

(54) NON-INTRUSIVE FLOW SENSING

(71) Applicant: Intelligent Water Management, Inc., Frederick, MD (US)

(72) Inventors: Kevin L. WILT, Shenandoah, WV (US); Paul B. WALTON, Silver Spring, MD (US); Robert DIDONATO, JR., Woodstock, MD (US)

(73) Assignee: Intelligent Water Management, Inc., Frederick, MD (US)

(21) Appl. No.: 15/446,310

(22) Filed: Mar. 1, 2017

Related U.S. Application Data
(60) Provisional application No. 62/431,164, filed on Dec. 7, 2016.
(60) Provisional application No. 62/324,928, filed on Apr. 20, 2016.
(60) Provisional application No. 62/302,229, filed on Mar. 2, 2016.

(51) Int. Cl. G01F 1/66; G01M 3/02

(52) U.S. Cl. CPC G01F 1/666; G01M 3/02; G01F 1/662

(57) ABSTRACT

A passive device for detecting fluid flow in a pipe includes a housing, a mechanical couple for attaching the housing to at least one of the pipe and a structure disposed in close proximity to the pipe, and a chamber disposed within the housing such that the chamber is physically isolated from the pipe. The chamber is sized and shaped to receive a sound wave at a first end thereof and to amplify the sound wave between the first end and a second end of the chamber, the sound wave including a frequency range corresponding to that of a predetermined fluid flowing through an interior of the pipe. A sensor disposed at the second end of the chamber receives the sound wave amplified by the chamber, and communications circuitry is configured to send a signal corresponding to the sound wave received by the sensor to an external computing device.

### CROSS-REFERENCE TO RELATED APPLICATIONS

This application claims the benefit under 35 U.S.C. §119(e) of U.S. Provisional Patent Application No. 62/302,229 filed on Mar. 2, 2016, U.S. Provisional Patent Application No. 62/324,928 filed on Apr. 20, 2016, and U.S. Provisional Patent Application No. 62/431,164 filed on Dec. 7, 2016, where the entire content of each of the foregoing applications is hereby incorporated by reference.

### BACKGROUND

Several applications exist that benefit from the detection of fluid flow through pipes. Examples include, but are not limited to, detecting a faucet that was left running, detecting a toilet that is leaking, detecting water flow to a hot water heater input and comparing it to the hot water flow output, checking to see if a valve has opened as expected, detecting propane or natural gas flow, and generally tracking fluid flow and usage.

Several solutions exist that allow detection of water flow and the flow of other fluids. Some examples include differential pressure sensors, Doppler Effect ultrasonic sensors, turbines, propellers, calorimetric sensors, as well as magnetic and gear flow meters. While these devices may generally fulfill their stated objectives, these solutions generally require modification to the existing plumbing to add them in-line with the fluid flow, or by inserting a probe. The installations of such fluid flow sensors have costs associated with each, primarily to hire a plumber to cut into the pipe, or otherwise to insert these devices into the path of the fluid. A device to detect fluid flow that is non-intrusive to plumbing would be beneficial. Accordingly, a fluid flow sensor that can be attached externally to a pipe containing the flowing fluid with some or all the benefits described above would provide advantages including ease of installation and lower costs.

### BRIEF DESCRIPTION OF THE DRAWINGS

The accompanying drawings provide visual representations which will be used to more fully describe various representative embodiments and can be used by those skilled in the art to better understand the representative embodiments disclosed and their inherent advantages. The drawings are not necessarily to scale, emphasis instead being placed upon illustrating the principles of the devices, systems, and methods described herein. In these drawings, like reference numerals may identify corresponding elements.

FIG. 1 illustrates a schematic of a non-intrusive flow sensor, in accordance with a representative embodiment.

FIG. 2 illustrates a bottom view of a schematic of a non-intrusive flow sensor, in accordance with a representative embodiment.

FIG. 3 illustrates options for the shape of a resonator, in accordance with representative embodiments.

FIG. 4 illustrates schematics of non-intrusive flow sensors, in accordance with representative embodiments.

FIG. 5 illustrates a system, in accordance with a representative embodiment.

FIG. 6 illustrates an acoustic chamber, in accordance with a representative embodiment.

FIG. 7 is a flow chart of a method for detecting fluid flow in a pipe, in accordance with a representative embodiment.

FIG. 8 is a flow chart of a method for determining if an acoustic signal from an audio flow sensor is water flow or noise, in accordance with a representative embodiment.

FIG. 9 is a flow chart of a method for locating a leak, in accordance with a representative embodiment.

FIG. 10 illustrates a timeline for the usage of a single fixture, in accordance with a representative embodiment.

FIG. 11 illustrates a timeline for the usage of multiple fixtures, in accordance with a representative embodiment.

FIG. 12 illustrates a timeline for the usage of multiple fixtures, in accordance with a representative embodiment.

FIG. 13 is a flow chart of a method of determining fluid flow in a piping system, in accordance with a representative embodiment.

### DETAILED DESCRIPTION

The various methods, systems, apparatus, and devices described herein generally provide for non-intrusive or passive flow sensing.

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

All documents mentioned herein are hereby incorporated by reference in their entirety. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms.

In general, the devices, systems, and methods described herein may include non-intrusive flow sensing, e.g., using an acoustic fluid flow sensor. As such, embodiments may generally relate to sensors that detect fluid, liquid or gas flow. More specifically, embodiments may relate to a flow sensor that can detect water or other fluids, liquid or gas, moving through a pipe by connecting the sensor externally to the pipe, or attaching it to a wall or any other surface adjacent to, or in close proximity of, the pipe. In this manner, the flow sensor may not require cutting into the pipe, drilling into the pipe, or any other technique that would modify the pipe in any manner. The flow sensor may be connected via a mechanical coupling (e.g., a pipe clamp) to the pipe, or attached to wall or any other surface that is covering, or in close proximity of, the pipe.

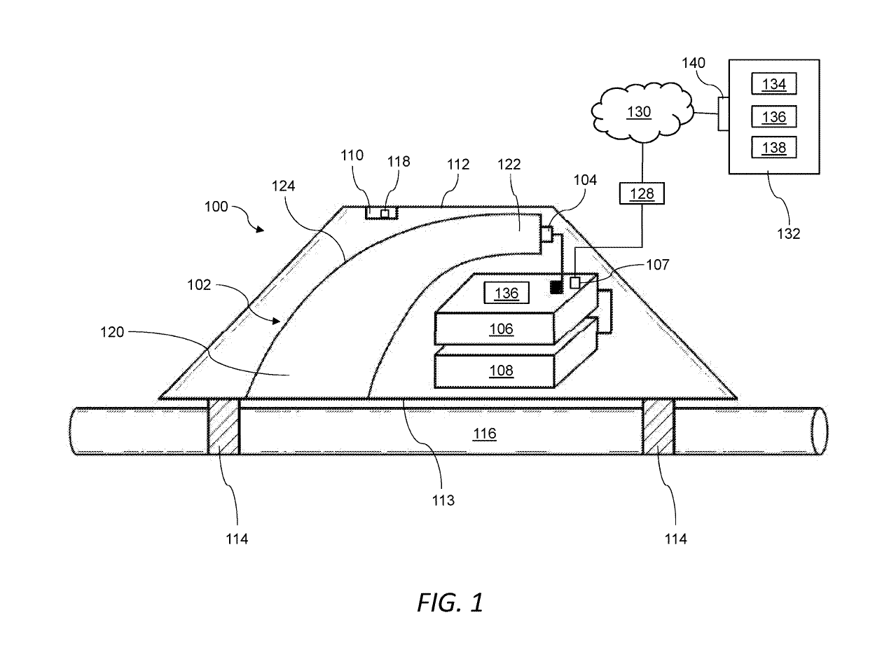

FIG. 1 illustrates a schematic of a non-intrusive flow sensor, in accordance with a representative embodiment. Specifically, FIG. 1 illustrates the flow sensor 100 when installed onto a pipe 116. In general, the flow sensor 100 may be referred to herein as “non-intrusive,” “passive,” and the like. It will be understood that, unless stated to the contrary or otherwise clear from the context, the flow sensor 100 being “non-intrusive,” “passive,” or the like shall refer to the flow sensor 100 being generally “non-intrusive” or “passive” relative to a pipe 116, conduit, fixture, equipment, or the like, for which the flow sensor 100 is to detect fluid flow or a leak therefrom. In other words, the flow sensor 100 being “non-intrusive” or the like may include that the flow sensor 100 is connected externally to the pipe 116, conduit, fixture, equipment, or the like, or the flow sensor 100 may be attached to a structure adjacent to the pipe 116, conduit, fixture, equipment, or the like, for which the flow sensor 100 is to detect fluid flow or a leak therefrom. Thus, the flow sensor 100 being generally “non-intrusive” may refer to the flow sensor 100 not requiring any cutting, drilling, modifying, or the like of the pipe 116, conduit, fixture, equipment, or the like, in any manner. Also, the flow sensor 100 being generally “passive” may refer to the flow sensor 100 receiving data from the pipe 116, conduit, fixture, equipment, or the like, without the flow sensor 100 transmitting signals (e.g., optical signals, acoustic signals, and the like) into the pipe 116, conduit, fixture, equipment, or the like. For example, the flow sensor 100 may instead only receive such signals (e.g., acoustic signals) from the pipe 116, conduit, fixture, equipment, or the like, at a location external to the pipe, conduit, fixture, equipment, or the like.

Thus, the non-intrusive flow sensor 100, or simply flow sensor 100, may be a passive device for detecting fluid flow in a pipe 116. The non-intrusive flow sensor 100 may include a chamber 102 that acts as a resonator, a sensor 104 (e.g., a microphone), a circuit board 106 featuring processing and communications circuitry, a power source 108, a noise canceling device 110, a housing 112, and an attachment device 114, e.g., for mechanically coupling the non-intrusive flow sensor 100 to a pipe 116 or other structure.

In general, FIG. 1 illustrates a representative diagram or schematic of an external fluid flow sensor 100 as installed onto a pipe 116, in accordance with a representative embodiment. Although the description of the embodiment shown in FIG. 1 is generally for water, one skilled in the art will recognize that other fluids are possible in gaseous or liquid states. If embodiments were being used to detect liquids or gases other than water, the same principles could apply, except that a frequency for detection of that fluid should be determined, and the flow sensor 100 should be configured for detecting that frequency as appropriate. Similarly, although the description of the embodiment shown in FIG. 1 is generally for detecting fluid flow at a pipe 116, the flow sensor 100 may be used to detect fluid flow at other conduits, fixtures, equipment, or the like.

The flow sensor 100 may be installed onto the pipe 116, or onto a structure disposed in close proximity to the pipe 116, such as a wall or any other surface that is covering the pipe or disposed adjacent to the pipe 116. It will be understood that being installed in “close proximity” to the pipe 116 may include locations on the external surface of the pipe 116, on adjacent structures to the pipe 116, or generally within an acoustic range for detecting fluid flow at a pipe 116 through audible noise (e.g., audible to a particular sensor or sensor system of the flow sensor 100) from the fluid flow within the pipe 116.

When water flows through a pipe 116, it generates audible noise, with the approximate frequency of about 1750 Hz being a possible component of that noise. The closed resonant chamber 102 (which may also be referred to herein as the chamber 102 or resonator) may thus be tuned to about 1750 Hz, where a sensor 104 (e.g., a microphone) is attached to the end of this chamber 102 to pick up any audio present. The audio may be further filtered and amplified on the circuit (e.g., by processing circuitry of the circuit board 106), which can be powered by a power source 108 such as batteries, direct current (DC) input, or any other alternative power source such as sound energy, kinetic energy, and the like. A threshold may be determined based on noise level and the 1750 Hz spike, for which it can be determined that water is flowing through a pipe 116. A detection signal 128, e.g., a water flow detect signal, may then be available to be sent wired or wirelessly to other systems for processing, or the such processing may occur locally at the flow sensor 100.

The chamber 102 may include a resonant chamber 102, where a curved chamber 102 is shown but other shapes are also or instead possible. The chamber 102 may be disposed within the housing 112 such that the chamber 102 is physically isolated from the pipe 116. This may include implementations where the chamber 102 is disposed entirely within the housing 112. This may instead include implementations where the chamber 102 is disposed mostly within the housing 112, or otherwise partially within the housing 112. In certain implementations, however, whether entirely or partially disposed within the housing 112, the chamber 102 may be physically isolated from the pipe 116. The chamber 102 may be sized and shaped to receive a sound wave at a first end 120 thereof, and to amplify the sound wave between the first end 120 and a second end 122 of the chamber 102. As discussed herein, the sound wave may include a frequency range corresponding to that of a predetermined fluid flowing through an interior of the pipe 116. The predetermined fluid may include one or more of water, natural gas, propane, oil, waste water, or other fluids. In certain implementations where the predetermined fluid is water, the frequency range of the sound wave may be about 1500 Hertz to about 2000 Hertz. For example, the frequency range may include a target frequency of about 1750 Hertz.

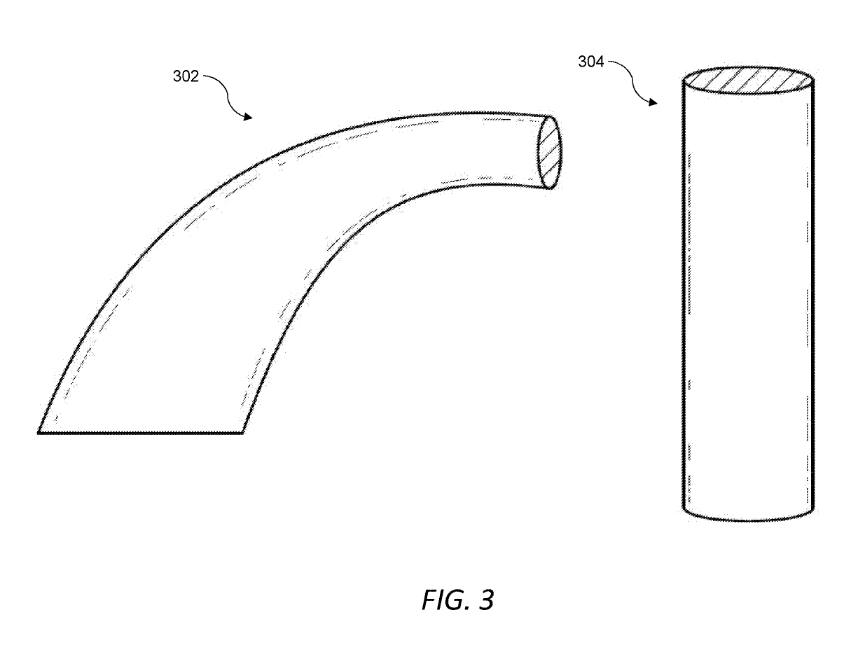

The chamber 102 may include a substantially tubular shape. The substantially tubular shape of the chamber 102 may be substantially straight between the first end 120 and the second end 122 of the chamber 102 (see, e.g., FIG. 3). The substantially tubular shape of the chamber 102 may instead include a curve 124 between the first end 120 and the second end 122 of the chamber 102 as shown in FIG. 1. In implementations, the substantially tubular shape is a cylinder. The chamber 102 may be open on the first end 120 and closed on the second end 122.

In certain implementations, the chamber 102 is mechanically configured to be tunable for a number of frequency ranges by adjusting one or more of a size and a shape of the chamber 102.

The sensor 104 may be disposed at the second end 122 of the chamber 102 to receive a sound wave amplified by the chamber 102. The sensor 104 may include a microphone or other similar audio sensor. The sensor 104 (e.g., microphone) may capture fluid flow audio. The sensor 104 may be one of a plurality of sensors 104. For example, the plurality of sensors 104 may include a plurality of microphones, e.g., a first microphone and a second microphone, where the second microphone is a noise canceling device that is used to absorb a certain sound before the sound wave is received by the first microphone. In this manner, the flow sensor 100 may include one or more noise canceling devices 110. In an implementation where the noise canceling device includes a second microphone 118, the second microphone 118 may send an audio signal to a processor 136 or the like (e.g., included on the circuit board 106 or on an external computing device 132), where the audio signal corresponds to external noise detected by the second microphone 118. The processor 136 may be configured to filter the external noise from the sound wave received by the sensor 104, e.g., prior to the communications circuitry 107 sending a signal 128 corresponding to the sound wave.

The circuit board 106 may include a custom circuit card assembly (CCA) containing additional filtering, amplification, and communications interface or circuitry (wired or wireless). The circuit board 106 may be included on a controller or the like, and may include communications circuitry 107 configured to send a signal 128, e.g., through a data network 130 to a computing device 132, e.g., external to the flow sensor 100. The signal 128 may correspond to the sound wave received by the sensor 104, and may thus include data related to the sound wave. The signal 128 corresponding to the sound wave may be wirelessly transmitted through a network, e.g., the data network 130 shown in the figure.

The power source 108 may include one or more batteries (e.g., AAA batteries). The power source 108 may also or instead include other forms of power, or other batteries, or any other alternative power source such as sound energy, kinetic energy, and the like. In certain implementations, the power source 108 includes an input from an AC/DC converter. For example, the power source 108 may include a direct current (DC) input.

The noise canceling device 110 may be optional in a flow sensor 100. The noise canceling device 110 may include a second microphone 118 used to cancel noise as explained herein.

The housing 112 may include a sensor case holding the components of the non-intrusive flow sensor 100. The housing 112 may be made from one or more of metal, plastic, glass, ceramic, wood, composite materials, and so on.

The attachment device 114 may include a mechanical couple, such as that shown in the figure, where the mechanical couple is structurally configured for attaching the housing 112 to at least one of the pipe 116 and a structure disposed in close proximity to the pipe 116. The attachment device 114 may include a clamping device holding the sensor body onto the pipe. Thus, the mechanical couple may include a clamp for attaching the housing 112 to an exterior of the pipe 116. The attachment device 114 may also or instead include an adhesive for attaching the housing 112 to a wall, where the pipe 116 is disposed behind the wall. The attachment device 114 may also or instead a cable, a clasp, a clamp, a clip, a gib, a glue, a hook and loop fastener, a latch, a tie, a snap, a wire, a magnet, and the like

The housing 112 may include a base portion 113 engaged with the attachment device 114 (e.g., mechanical couple), where the chamber 102 is disposed within the housing 112 with an opening in the first end 120 directed toward the base portion 113.

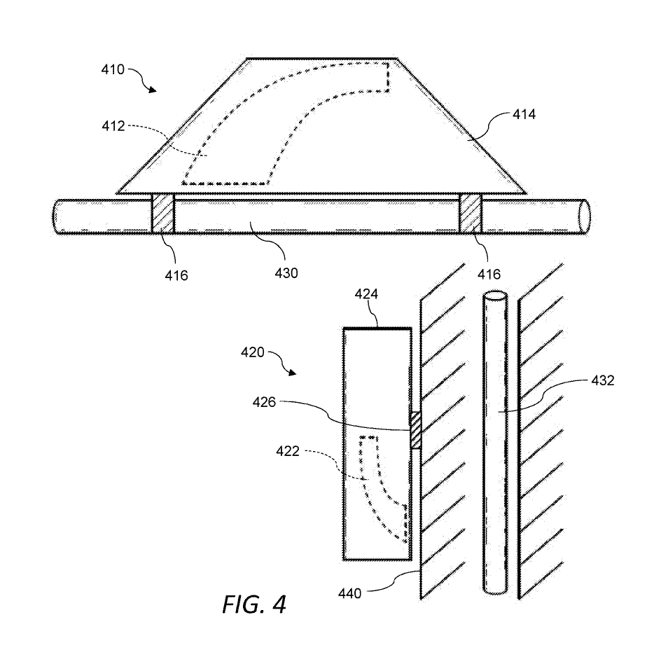

Thus, the housing 112 or case may contain the resonant device, which may be wholly or partially formed by a chamber 102. The housing 112 may also include the sensor 104 to detect characteristic fluid flow frequencies (e.g., 1750 Hz for water), the circuit board 106 (e.g., a Custom CCA) with filtering, amplification, communications circuitry 117 or interface, and processing circuitry, a power source 108 utilizing either batteries, a DC input, or any other alternative power source such as sound energy, kinetic energy, etc., and an optional noise canceling device 110 (e.g., a second microphone). The housing 112 or case may be mounted onto the pipe 116 in which fluid flows through, with an attachment device 114 to clamp or otherwise connect the housing 112 to the pipe 116. If the pipe 116 is not accessible, the housing 112 may be mounted to a wall or any other surface or structure in close proximity to where the pipe 116 is positioned (e.g., as shown in FIG. 4 described below).

When fluid flows through a pipe 116, a characteristic frequency may be present for detection by one or more flow sensors 100. As discussed herein, this frequency may be approximately 1750 Hz for water. There may be some minor variation in frequency depending on a number of factors, e.g., the pipe material used, but this may not affect the ability to detect fluid flow using the disclosed embodiments. However, the type of material used for the pipe 116 may affect the amplitude of the acoustic signal, which can be compensated for by amplification on the Custom CCA, for example. The flow sensor 100 containing the resonator, e.g., the resonant chamber 102, may be positioned with an opening over the pipe 116 to detect audio. If the pipe 116 is not exposed, the flow sensor 100 containing the resonant chamber 102 may be attached to a wall or any other surface covering the pipe 116. Effort may be made to isolate background noise from getting into the opening and/or cancel background noise, e.g., with a secondary microphone 118. The resonant chamber 102 may be tuned to approximately 1750 Hz for water, which acts to filter out unwanted frequencies and also acts to amplify the desired frequency. Note that the resonant chamber 102 can be many shapes, e.g., providing it is tuned or built to approximately 1750 Hz (for water). Background noises include components of many frequencies, including the desired frequency, and may add to the amplitude of the detected acoustic signal. Further processing may be used to determine if a detected acoustic signal is due to noise or fluid flow, typically setting a threshold and optionally noise canceling. The audio in the resonant chamber 102 may be captured by the sensor 104, and set to the circuit board 106, e.g., Custom CCA, for processing. The Custom CCA may process the acoustic signal by further filtering any unwanted frequencies, amplifying the desired frequency, employing noise canceling techniques if included by processing audio from the second microphone 118 to generate a final audio signal. The final audio signal may be evaluated to determine if the level detected is above the threshold to validate if fluid flow is detected, or if it was just noise. If it is determined that fluid flow was detected, the detected signal may be transmitted off the board, either wirelessly or wired, for use in a higher-level system. This detected signal may contain amplitude information that is available for the device to which it is transmitting.

The data network 130 may be any network(s) or internetwork(s) suitable for communicating data and control information among participants in a system including one or more flow sensors 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m) and/or other technologies, as well as any of a variety of corporate area or local area networks and other switches, routers, hubs, gateways, and the like that might be used to carry data among participants in a system including one or more flow sensors 100. The data network 130 may include wired or wireless networks, or any combination thereof. One skilled in the art will also recognize that components of a system including one or more flow sensors 100 need not be connected by a data network 130, and thus can be configured to work in conjunction with other participants independent of the data network 130. The data network 130 may also or instead include a network specifically configured for home automation, e.g., one or more of Z-Wave, Wi-Fi, ZigBee, and Bluetooth.

The computing device 132 may include any devices within systems as described herein operated by operators or users to manage, monitor, communicate with, or otherwise interact with other participants or components in the systems. This may include desktop computers, laptop computers, network computers, tablets, smartphones, smart watches, PDAs, small form factor computers, wearable computers, home automation devices, or any other computing device that can participate in the systems as contemplated herein. In certain implementations, the computing device 132 (and an operator interface thereof) is not external to a flow sensor 100, but instead is integral with the housing 112 or other component of the flow sensor 100. In certain implementations, the computing device 132 is an external computing device including a small form factor computer, where the small form factor computer is configured to process data from the sensor 104. In particular, the small form factor computer may include a computing device structurally configured to minimize the volume of a desktop computer. In certain implementations, the computing device 132 is a smartphone, where the smartphone includes a user interface 134 and a communications interface 140. The smartphone, or other computing device 132, may include a processor 136 configured to determine whether fluid flow is present in the pipe 116 from the signal 128. The communications interface 140, e.g., of the smartphone or other computing device 132, may be configured to receive a notification regarding fluid flow in the pipe 116 from the sensor 128.

The computing device 132 may generally provide a user interface 134, which may include a graphical user interface, a text or command line interface, a voice-controlled interface, and/or a gesture-based interface. In general, the user interface 134 may create a suitable display on the computing device 132 for operator or user interaction. In implementations, the user interface 134 may control operation of one or more of the components of the systems as described herein, e.g., the flow sensors 100, as well as provide access to and communication with controllers, databases, and other resources.

The user interface 134 may be maintained by a locally executing application on the computing device 132 that receives data from one or more of the components of a system including one or more flow sensors 100 or other resources. In other embodiments, the user interface 134 may be remotely served and presented on one of the computing devices 132, such as where the circuit board 106, controller, or a server includes a web server that provides information through one or more web pages or the like that can be displayed within a web browser or similar client executing on one of the computing devices 132.

Other hardware included in systems described herein may include input devices such as a keyboard, a touchpad, a computer mouse, a switch, a dial, a button, and the like, as well as output devices such as a display, a speaker or other audio transducer, light emitting diodes, and the like. Other hardware in systems described herein may also or instead include a variety of cable connections and/or hardware adapters for connecting to, e.g., external computers, external hardware, external instrumentation or data acquisition systems, and the like.

One or more flow sensors 100 included in a system, or another component of a system such as the computing device 132, may include a processor 136 and a memory 138. For example, the processor 136 and the memory 138 may be included on the circuit board 106 or the like of the flow sensor 100.

The processor 136 may be configured to perform filtering of the sound wave received by the sensor 104. The processor 136 may also or instead be configured to perform further amplification of the sound wave received by the sensor 104. The filtering and further amplification of the sound wave may occur prior to the communications circuitry 107 sending the signal 128 to the computing device 132, or after the communications circuitry 107 sends the signal 128 to the computing device 132—e.g., the filtering and further amplification of the sound wave may occur at the flow sensor 100 (e.g., using a processor disposed in the circuit board 106) or on the computing device 132 (e.g., using a processor 136 disposed on the computing device 132 as shown in the figure).

In implementations, the processor 136 performs filtering that includes removing one or more unwanted frequencies from the sound wave received by the sensor 104. In implementations, the processor 136 performs further amplification of the sound, where the further amplification includes amplifying a target frequency included in the sound wave received by the sensor 104. As discussed herein, the target frequency may be about 1750 Hertz.

The processor 136 may be configured to determine if the sound wave received by the sensor 104 is above a threshold value for confirmed fluid flow. The threshold value for confirmed fluid flow may be selected such that any sound wave having certain characteristics above this threshold value can be inferred to be fluid flowing through a piping system, and where it may be indeterminate or inconclusive for sound waves having certain characteristics below this threshold value. Thus, the signal 128 may include an indication of fluid flow in the pipe 116 when the sound wave received by the sensor 104 is above the threshold value. The signal 128 corresponding to the sound wave may also or instead otherwise include an indication of fluid flow in the pipe 116. The signal 128 corresponding to the sound wave may also or instead include amplitude information, frequency information, wavelength information, sound pressure information, intensity information, time information, and so on. Similarly, the threshold value may be related to one or more of a frequency, a wavelength, an amplitude, a sound pressure, an intensity, and a duration of the sound wave received by the sensor 104. The threshold value may be a dynamic threshold value.

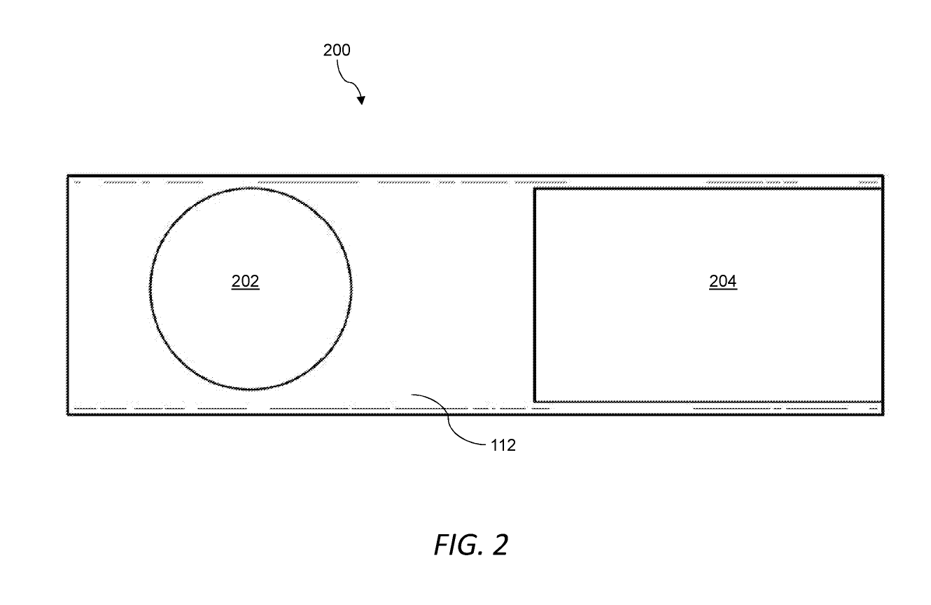

FIG. 2 illustrates a bottom view of a non-intrusive flow sensor, in accordance with a representative embodiment. The non-intrusive flow sensor 200 shown in this figure may be the same or similar to the non-intrusive flow sensor 100 shown in FIG. 1. The figure shows the opening 202 of a resonant chamber to capture the sound of a flowing fluid, the housing 112 or sensor case, and a possible location of a battery compartment 204 for the power source if present. The power source may also or instead include a DC input, or any other alternative power source such as sound energy, kinetic energy, and the like. In this figure, batteries are installed within the battery compartment 204 for relatively easy replacement.

The opening 202 of the resonating chamber may be positioned directly over the pipe or as close as possible to the pipe. Because the detect signal may contain amplitude information, particular amplitudes can be monitored while the flow sensor 200 is positioned. This may be especially helpful if installing onto a wall or any other surface covering the pipe, since the pipe is not visible.

FIG. 3 illustrates options for the shape of a resonator, in accordance with representative embodiments. Specifically, FIG. 3 shows two examples of shapes of different resonant chambers—a first chamber 302 and a second chamber 304. Additional shapes are acceptable as long as they are tuned to an appropriate approximate frequency for a particular application. The first chamber 302 shows a curved shaped chamber, typically including a hollow tube. Use of a curved tube may help to reduce overall size of a flow sensor. The second chamber 304 shows a straight tube. Use of a straight tube can be used when size of a flow sensor is not a constraint and may be easy to manufacture and calculate a desired length.

Thus, two resonator chamber options—a first chamber 302 and a second chamber 304—both may be closed at one end, where a sensor is placed within the chamber or adjacent to the chamber to detect audio. The first chamber 302 is a curved resonator chamber, which is also what is depicted in FIG. 1. This shape may be useful to maintain a low-profile sensor. It may come at the expense of a more complex shape, which can make the sensor more expensive to manufacture and can limit available materials. Tuning may be determined by building a chamber that is excessive in length, cutting the length, and measuring the resultant resonant frequency. The second chamber 304 is straight, which can make it easier to manufacture, easier to calculate the resonant frequency, and thus less expensive to manufacture. A downside may include that it may have a higher profile sensor with less flexibility in sizing. Additional shapes are available to use as resonating chambers providing they can be tuned to the desired frequency. This can be a consideration when creating a final shape and design for a particular sensor.

FIG. 4 illustrates non-intrusive flow sensors, in accordance with representative embodiments. Specifically, FIG. 4 shows mounting options for two flow sensors—a first flow sensor 410 and a second flow sensor 420.

The first flow sensor 410 is shown attached to a first pipe 430, where the first pipe 430 may be configured for having a fluid flowing therein. The first flow sensor 410 also shows a resonator chamber 412 and a housing 414 or sensor case.

The first flow sensor 410 may include a first mechanical couple 416 for attaching to the first pipe 430. As shown in the figure, the first mechanical couple 416 may include a clamp or strap or the like, secured wholly or partially around the exterior of the first pipe 430. The first mechanical couple 416 may also or instead include a cable, a clip, a gib, a glue, a hook and loop fastener, a latch, a tie, a snap, a wire, a magnet, a glue or other adhesive, and the like.

The second flow sensor 420 is shown attached to a wall 440, which may also or instead include any surface or structure disposed adjacent to, or in close proximity to, a second pipe 432, where the second pipe 432 may be configured for having a fluid flowing therein. The second flow sensor 420 also shows a resonator chamber 422 and a housing 424 or sensor case.

The second flow sensor 420 may include a second mechanical couple 426 for attaching to the wall 440 or another structure in close proximity to the second pipe 432. The second mechanical couple 426 may include a bolt, a clip, a clamp, a dowel, a gib, a glue or other adhesive, a hook and loop fastener, a latch, a nail, a nut, a pin, a rivet, a screw, a slider, a snap, a spike, and the like.

In implementations, the fluid flow sensor may preferably be installed onto the pipe from which it is desired to detect fluid flow. In the event the pipe is not available, such as in the case that the pipe is entirely covered by a wall or any other surface material, the flow sensor may be installed onto the wall or any other surface as close to the pipe as possible. If installed onto a wall or any other surface, the amplitude of the desired fluid flow signal may be reduced, which is compensated for in part by amplification on the Custom CCA or controller.

Thus, FIG. 4 shows two options for mounting the flow sensor over the pipe with fluid flowing therein. The first flow sensor 410 is shown in a first mounting option, with the first flow sensor 410 mounted to the first pipe 430. This may not always be practical when pipes are not exposed, but are covered by walls or any other surface, such as showers, hose bibs, runs of pipe through a house, and others. As shown by the second flow sensor 420, the housing 424 may instead be mounted to a wall 440 or any other surface or structure that is in front of, adjacent to, or in close proximity to, a pipe. The flow sensor may detect output, which can contain an amplitude number, which can then be used to help place the flow sensor in an optimal location.

Implementations may include a device that detects fluid flow through a pipe by analyzing audio signals. Implementations may include a device that can sense fluid flowing through a pipe by externally attaching the device to the pipe, and not altering the pipe. Implementations may include a device that can be attached to a wall or any other surface to detect fluid flowing through a pipe behind the wall or any other surface. Implementations may include a use of a resonant chamber tuned to the frequency prevalent of a particular fluid flow through pipes to filter unwanted frequencies and to amplify the desired frequency prior to capturing the audio with a microphone. For water, this frequency may be approximately 1750 Hz. Other fluids, liquid or gas, may have different frequencies that can be determined. Implementations may include a use of a Custom Circuit Card Assembly (CCA) to provide additional filtering, amplification, noise versus flow determination, and an interface for the function of detecting fluid flow through pipes. Implementations may also include a system, e.g., using the device described above. The system may incorporate or supplement any of the devices, systems, and methods described in U.S. Pat. No. 7,306,008 and U.S. Pat. No. 7,900,647, which are hereby incorporated by reference in their entirety.

A system may include an externally connected acoustic flow sensor. One of the challenges in developing flow sensor systems is that flow sensors being used typically are installed into the piping. Since several sensors may be used, an improvement may include a water flow sensor that does not alter the plumbing, and can be applied externally. While a piezoelectric film can be used in implementations, it may be more useful for higher flows rates than acoustic technology. Attempting to determine a magnetic flow within water can also or instead be used in implementations, but it can be difficult due to the extremely low magnetism of water. Electrically charging the water can be used, but it runs the risk of developing pinhole leaks due to electrolysis. Temperature sensors can also or instead be used in implementations to sense minute temperature changes in flowing water. This can, however, take too long to be effective. Using acoustic sensing technology may thus be a preferred use to detect water flow without having to break into the plumbing.

A system may include water conservation algorithms. The leak detection techniques can be expanded to assist in helping to conserve water. One of these methods may include monitoring trends in water use per device/fixture. For example, the water use of a bathroom can be monitored against national averages, household averages, or trends in its own specific use. When anomalies are observed, notifications can be sent to a user to investigate the cause to further determine if water conservations techniques could be used or if there was a justified reason for an increase. Another algorithm that can be used may monitor water profiles against expected usage. For example, a toilet typically uses water for an extended period of time during fill. This time may vary slightly based on water pressure and if other devices/fixtures are being used. When a flapper valve leaks, the water may fill for a very short time to top off the tank. This time can be fairly consistent but the time period between fills can decrease as a flapper valve deteriorates. This behavior can be detected using devices and systems described herein, and a notification can be sent to the user for action to replace the flapper valve and conserve water. Another example is that there may be occasions where someone does not fully close a valve after use, thereby causing it to drip. By monitoring the system pressure and water usage, devices and systems described herein may be able to detect if this drip was caused by a deteriorating faucet, or user error in closing the valve, and the user can be notified for appropriate action.

A system may include monitoring flow per device. The overall system may include a flow meter installed to accurately measure water flow. This may be a totalizer flow meter or a meter with a pulse output which is totalized on a system. The system may know how much water has flowed at any specific time. The system can detect a flow at a device in the system. Once the water stops flowing, the system can compare how much water flowed during the time that the device was activated. This is the device flow for that particular use, which can be stored. It is also possible that several devices may be simultaneously experiencing water flow. In this case, the system may have expected water flow rates for all devices and can allocate by estimation the water flow per device. These expected water flow rates can be default values, or improved by calibrating during installation, and improved as data enters the system.

A system may utilize home automation technology. A system may include a smart home protocol such as a Z-Wave wireless link (or similar) for the various sensors and controller(s) in the system. Other smart home protocols, networks, and communication techniques, such as ZigBee, Wi-Fi, Bluetooth Low Energy (BLE), and Ultra Low Energy (ULE) may also or instead be used. The entire system may appear as a device to home automation controllers. Additional messaging can be provided via Wi-Fi through the cloud.

A system may include remote monitoring and control, e.g., via a mobile device such as a smartphone or the like. This may include applications to interface the smartphone/tablet to the controls and notifications for the system. This may include flow monitoring, leak detection (notifications), drip detection (notifications), shutoff valve control (e.g., via a solenoid valve or the like), and so forth.

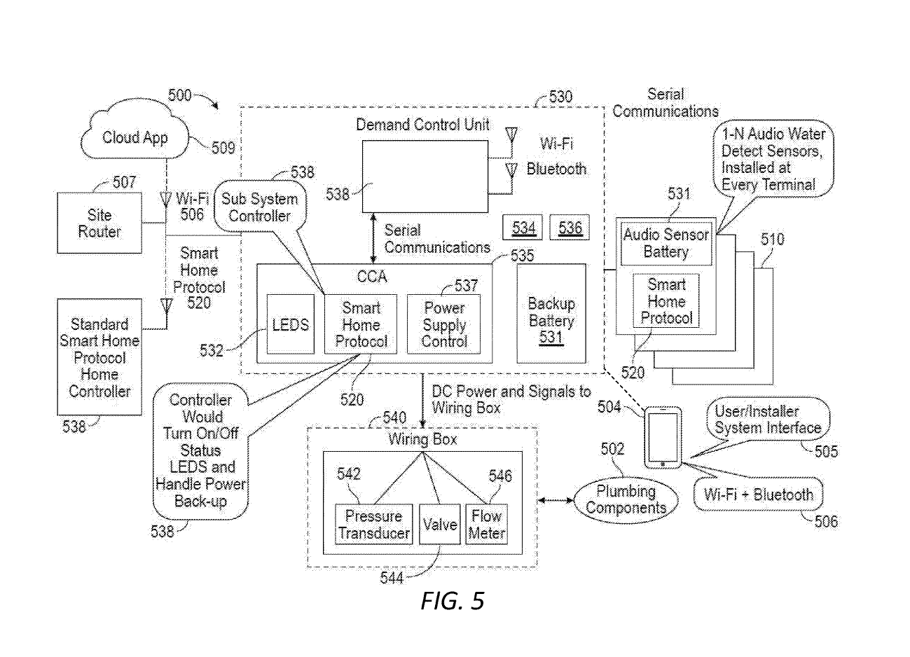

FIG. 5 illustrates a system, in accordance with a representative embodiment.

The system 500 may include a water leak and drip detection system that includes several components. The system 500 may include one or more sensors 510, e.g., flow sensors having acoustic (audio) sensors as described herein, which may be mounted to a pipe or a surface or structure in close proximity to a pipe, e.g., at or near one or more water-using devices (e.g., plumbing fixtures). These sensors 510 may detect water flowing through a pipe or fixture and send a signal via a smart home protocol 520 (e.g., Z-Wave wireless circuitry), or other communications protocol, to a demand control unit 530.

The demand control unit 530 may monitor activity from the one or more sensors 510. The demand control unit 530 may also or instead be in communication with (e.g., electrically coupled, wired or wirelessly) a wiring box 540 or the like that includes various components therein or is in communication with various components, e.g., one or more pressure transducers 542, valves 544, flow meters 546, and so on, which may be monitoring one or more plumbing components 502 (e.g., plumbing fixtures). Thus, the demand control unit 530 may monitor system pressure (via a pressure transducer 542) to make a determination (a) to open one or more valves 544 to allow water flow (e.g., solenoid valves), (b) to detect drips and notify a user of the system 500, and/or (c) to detect leaks and flag one or more valves 544 to close or stay closed. It may also accept flow meter pulse counts, totalize them for use by the algorithms, and allocate water use activity by device. The demand control unit 530 may also or instead provide power and status circuitry for the system 500 and the plumbing components 502, e.g., via one or more indicators 532. The indicators 532 may include visual indicators such as LEDs or the like, audio indicators, tactile indicators, or combinations thereof.

The demand control unit 530 may also or instead contain programming such as one or more algorithms (e.g., stored on a memory 534 and implemented by a processor 536) that help make determinations if sensor activity is due to drips, leaks, legitimate flow, or false positives. These calculations and algorithms may be performed on the processor 536, which may include a microprocessor such as a Raspberry Pi microprocessor, where the microprocessor may be disposed in the system 500, in a remote server (e.g., a cloud-based server), a computing device 504 such as a smartphone or tablet, and the like. Alternatively, these calculations and algorithms may be performed directly on a Z-Wave IC or similar.

The demand control unit 530 may also or instead provide messages or notifications provided to and from one or more controllers 538 (e.g., Z-Wave controllers) for inclusion in home automation systems. If a home automation system is not present, the one or more controllers 538 can act as the primary controller for a water leak and drip system.

The demand control unit 530 may include a CCA 535 that includes or controls one or more of the indicators 532, a communications interface such as for smart home protocol 520, and a power supply control 537.

A power source 531 such as a backup battery may also or instead be provided in the demand control unit 530, e.g., to provide continuous operation in the event of a power loss.

The demand control unit 530 may have communications capability over a network 506, e.g., Wi-Fi for access to “the Cloud” 509 via a local router 507 for additional functionality not provided by the one or more controllers 538 (e.g., Z-Wave). This could optionally also be done with Bluetooth technology or the like. The system may also or instead include a communications link, e.g., for initial installation. This can include a link with Wi-Fi, Bluetooth, or any other communications protocols or systems.

Applications for mobile operating systems may provide an interface 505, e.g., a remote interface, for the user for valve control and system monitoring. The information provided on the interface 505 may include the operational state of a valve 544, the status of a sensor 510 (e.g., acoustic sensor status), and historical flow data. The flow data may also or instead be presented in customizable formats intended to highlight areas of possible water conservation improvements.

The plumbing components 502 may include wiring for coupling to one or more components of the system 500. These may be wired through the wiring box 540, which in turn is connected to the demand control unit 530. The plumbing components 502 may be hard-wired. The interface to these could be wireless (e.g., through a smart home protocol 520 connection), but in order to minimize traffic and collisions, they may also or instead be hard-wired. A pressure transducer 542 and similar components may have power provided to it by the demand control unit 530 and may generate an analog voltage to be presented to the demand control unit 530. The demand control unit 530 may convert this into a digital word for processing. One or more of the valves 544, e.g., a main valve, may be normally closed, and opens upon being powered. Power may be provided by the demand control unit 530 via a relay when it should be opened. When power is removed, the valve 544 may return to closed. A flow meter 546 may provide flow data to the demand control unit 530 for processing. The flow meter 546 may include a Hall Effect device with a pulse output. Another flow meter 546 may also or instead be used. Additionally, a manual bypass valve or the like may be optionally provided to allow water service to be restored in the event of system maintenance, or in the event of power loss, e.g., where the water supply is provided by a well or any other electrically controlled device. The demand control unit 530 may monitor if a bypass valve is open to alert the user (e.g., where the system 500 is not protected in this state).

A technique for determining the acoustic chamber size of an acoustic flow sensor will now be described.

Formulas for determining resonant frequencies of relatively simple shapes are readily available, where the acoustic chamber may include one or more of these relatively simple shapes. For example, for a closed cylinder, the resonant frequency, f, may be determined by the formula:

f=nv/4L

In this equation: f=desired resonant frequency; n=harmonic; v=speed of sound; and L=length of tube.

By way of example, it may be assumed that f=1750 Hz, n=1 (fundamental), and v=346.13 m/s (at 25° C.).

Because L=nv/4f, L=((1)*(346.13 m/s))/(4*1750 cycles/sec)=0.0494 m=1.945 in.

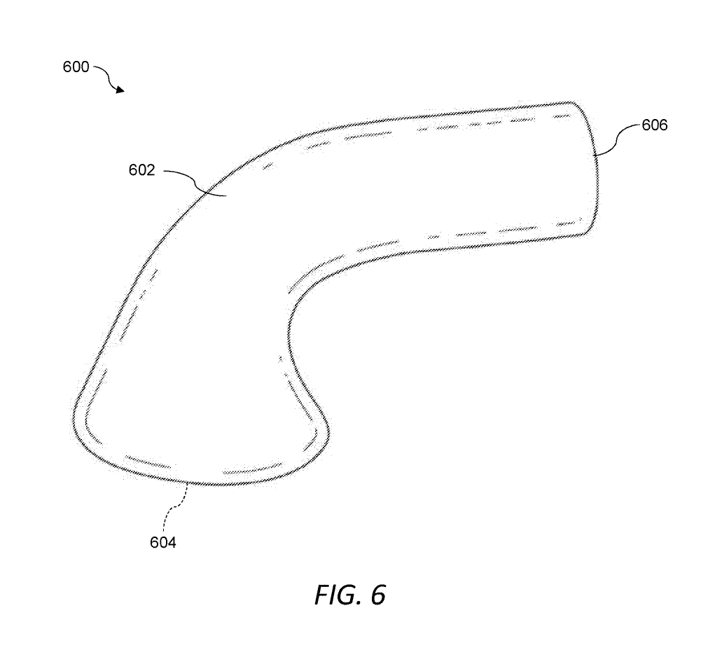

FIG. 6 illustrates an acoustic chamber, in accordance with a representative embodiment. In an example application, the acoustic chamber 600 is mounted substantially perpendicular to a pipe, where the acoustic chamber 600 includes a curve 602 at one end to provide a gradual bend at a tube that forms at least part of the acoustic chamber 600. Additionally, an end that is attached to the pipe may include an opening 604, e.g., a flared opening 604, to enhance the capture of sound. The portion that is bent substantially horizontal may remain substantially cylindrical. However, because this design may complicate the tuning of the acoustic chamber 600, a desired frequency may be determined by starting with a length known to be too long, measuring the resonant response, cutting the end of the chamber off (trimming), and re-measuring. This process may be repeated until the final length of the design is found. At this point, the size may be captured and documented. The resulting shape of the acoustic chamber 600 according to an example embodiment is shown in FIG. 6. The flared opening 604 may be pointed at the water flow source for maximum response. The microphone may be mounted on the closed side 606 to pick up the frequencies in the acoustic chamber 600. In other implementations, both ends of the acoustic chamber 600 are open; and in other embodiments, both ends of the acoustic chamber 600 are closed.

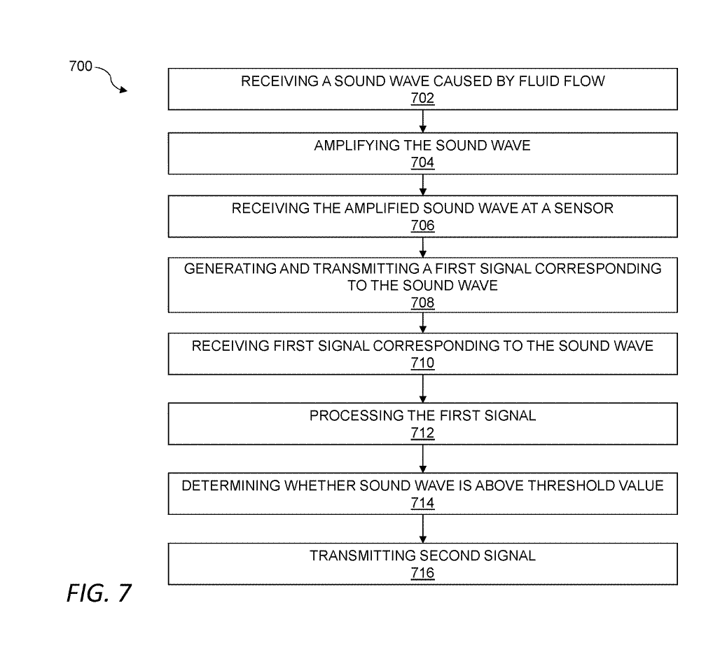

FIG. 7 is a flow chart of a method for detecting fluid flow in a pipe. The method 700 may be performed by any of the devices and systems described herein, e.g., flow sensors.

As shown in box 702, the method 700 may include receiving a sound wave caused by fluid flow, e.g., fluid flow in a pipe (or conduit, fixture, or the like). The sound wave may be received by a flow sensor, and more specifically at a first end of a chamber of a flow sensor that is physically isolated from the pipe, where the chamber is sized and shaped to amplify the sound wave between the first end and a second end of the chamber. The sound wave may include a frequency range corresponding to that of a predetermined fluid flowing through an interior of the pipe.

As shown in box 704, the method 700 may include amplifying the sound wave, e.g., between the first end and the second end of the chamber of the flow sensor. The sound wave may be amplified by the shape of the chamber before being received by a sensor, e.g., a microphone.

As shown in box 706, the method 700 may include receiving the sound wave amplified by the chamber at a sensor disposed at the second end of the chamber. The sensor may include a microphone or other receiver.

As shown in box 708, the method 700 may include generating a first signal corresponding to the sound wave, and transmitting the first signal for processing. The first signal may be generated and transmitted by the sensor itself, or by processing circuitry coupled with or otherwise in communication with the sensor. The first signal may be transmitted to an external processing device, e.g., a remote computing device or remote server, for further processing. Alternatively, the first signal may be further processed internally, e.g., within processing circuitry disposed on the flow sensor.

As shown in box 710, the method 700 may include receiving a first signal corresponding to the sound wave that was received by the sensor at a processor. As discussed herein, the processor may be an internal processor, e.g., integral with the flow sensor, or an external processor, e.g., disposed on a remote computing device or a remote server, or in communication with a remote computing device or a remote server.

As shown in box 712, the method 700 may include processing, with the processor, the first signal. The processing may include filtering of the sound wave received by the sensor. The processing may also or instead include further amplification of the sound wave received by the sensor.

As shown in box 714, the method 700 may include determining, with the processor, whether the sound wave received by the sensor is above a dynamic threshold value for confirmed fluid flow by analyzing the processed first signal.

As shown in box 716, the method 700 may include transmitting, using communications circuitry coupled to the processor, a second signal including an indication of fluid flow in the pipe to an external computing device when the sound wave received by the sensor is above the threshold value. The second signal may include a notification or the like for a user interface of a flow sensor, a control panel, a computing device, and so on. The notification may include a visual alert, data, a standard messaging service message, an instant message, a push notification, an audio alert, a tactile alert, and so on.

Techniques for determining if an acoustic signal from an audio flow sensor is water flow or noise will now be discussed.

Because a flow sensor may use audio to sense water flowing through pipes, it is possible that background noise will also be detected as audio. Several techniques may be used to prevent background noise from being perceived as audio. By way of example, these techniques may include filtering down to the characteristic frequency generated when water flows through pipes, noise isolation methods to prevent background audio noise from getting to the sensor, and combinations thereof. Noise canceling circuitry and techniques can also or instead be used. Due to the low audio levels that are generally detected by such systems and devices as described herein, it may still be possible for noise to be detected as flow and therefore further validation may advantageously be performed.

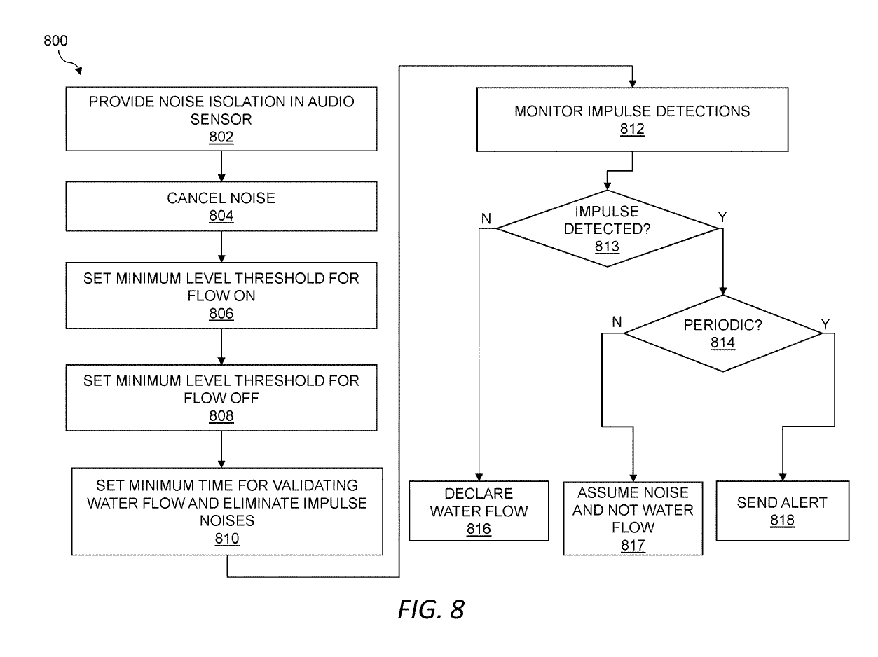

FIG. 8 is a flow chart of a method for determining if an acoustic signal from an audio flow sensor is water flow or noise, in accordance with a representative embodiment. One technique to avoid background noise from being detected as audio is to prevent the noise from reaching a microphone in the flow sensor. To this end, noise canceling techniques may be used. Additional steps can further distinguish background noise from water flow. The method 800 in the figure shows an example of various actions in increasing granularity that may be taken.

As shown in box 802, the method 800 may include designing noise isolation into the audio sensor. Preventing background noise from getting to a microphone in the flow sensor may be the first action taken in preventing false positives. This can be accomplished in a number of ways, including, for example: positioning the microphone away from noise sources and reflections; using acoustic foam or the like to dampen unwanted noise sources; and/or baffling (similar to a muffler or the like) to attenuate unwanted noise before it reaches the microphone. Some or all of these techniques may be used in a device or system design.

As shown in box 804, the method 800 may include using noise cancellation techniques to cancel ambient noise. Several noise cancellation techniques may be readily available. These include passive noise cancellation techniques, which may sum the interference of an unwanted noise signal and its reflection for presentation to the microphone (e.g., through the shape of the flow sensor or other corresponding component), and active noise cancellation which may use a second microphone for electronically canceling the noise that is common to both microphones. One or both of these noise cancellation techniques may be used in a device or system design.

As shown in box 806, the method 800 may include setting a minimum level threshold for flow ON. The analog acoustic level may be filtered to the characteristic frequency using mechanical and electrical techniques, and then amplified, which is then converted to a digital value and sent to a microcontroller for processing. Through experimental techniques, a lower threshold may be set to distinguish background noise from a possible desired acoustic indication of a water flow event. If this threshold is passed, the digital audio amplitude may be sent wirelessly to the controller for further validation.

As shown in box 808, the method 800 may include setting a minimum level threshold for flow OFF. The analog acoustic level may be filtered to the characteristic frequency using mechanical and electrical techniques, and then amplified, which is then converted to a digital value and sent to a microcontroller for processing. Once a flow ON has been indicated, the digital audio amplitude may be monitored to detect that it has dropped below a threshold which would indicate that water has stopped flowing. To add hysteresis into the system, the flow ON and flow OFF thresholds may not be the same value.

As shown in box 810, the method 800 may include setting a minimum time for validating water flow and eliminating possible false positives. The time between flow ON and flow OFF signals may be used to calculate a water flow duration value. For example, when water flow has been demanded, the water will generally flow for long enough to satisfy the water volume requirement. This amount of time may be about one second or more. In this example, any water flow duration of less than one second is likely due to impulse background noise or water drips. This can be used to help eliminate false positives. In other words, regular periodic short flow durations may be caused by a drip, and isolated short flow durations may be due to brief impulse noises, which can generally be safely ignored by the system.

As shown in box 812, the method 800 may include continuing to monitor impulse detections. As shown in box 813, a determination of whether an impulse was detected may be made by techniques and systems described herein. As shown in box 814, if an impulse is detected, then a determination of whether an impulse is periodic may be made by techniques and systems described herein. If an impulse detection is determined to be periodic, this may indicate a drip and an alert may be sent as per box 818. If an impulse detection is not periodic, the method 800 may proceed to box 817, where the techniques and systems may assume that the impulse detection is noise and not water flow. In other words, if detected short noise durations are regular and are coming from the same sensor, an alert may be sent to a user, where such an alert may include sensor identical information as well as details about the possible drip for further investigation. However, if an impulse noise is not periodic, then it may be assumed that background noise triggered the sensor, and water flow should not be declared and the method 800 may proceed to box 817. It is also possible to declare water flow if the impulse detection includes certain characteristics that meet a threshold for declaring water flow.

As shown in box 816, the method 800 may include declaring validated water flow if all thresholds and timers are met, and there are no impulse detections. False positive water flow events may be minimized by evaluating all data involved, including audio amplitude thresholds and durations being met. If the flow ON minimum threshold and flow duration have been met, a water flow event may be created. Similarly, once the flow OFF threshold has been met, a water flow completed event may be created.

Thus, if a signal is detected, a determination may be made as to whether the signal is a quick burst then nothing or a continuous signal, where the quick burst may be a leak (e.g., drip) and the continuous signal may be a flow condition. That is, if the signal is a continuous signal, it may be assumed that this is audio of a flow and a flow signal may be transmitted. If the signal is a quick burst, then monitoring can occur to determine whether the signal is periodic. If the signal is periodic, it may be identified as a drip. If the signal is simply a brief, non-periodic burst, it may be identified as background noise and be ignored. Thus, analyses may be performed for brief, non-continuous signals for a determination of whether such signals are background noise, drips, possible drips, or even flow.

Determining which water device may be leaking below a predetermined detection threshold will now be discussed.

One goal of the devices, systems, and methods described herein may include being able to identify when unwanted water flow is occurring. When water flow is strong enough to be detected by the flow sensors, the flow sensor may report the flow and the controller (e.g., a demand control unit as described herein) may make a determination about whether the water flow is wanted or unwanted.

Below a certain threshold level, the system may determine that there is a leak based on a pressure drop. When there is a pressure drop with no detectable audio, the system may open the valve to re-pressurize a pipe system to prevent undesired water shutoff. If the pressure continues to drop with no detectable water flow from the audio sensors, and the flow meter indicates that water flow has occurred, the system may recognize this as a leak and set the valve to closed, which may then allow for intervention by a user to open it again. It may be desirable to be able to report where the leak is located or may be located.

When the water system has been operating with no leaks and suddenly a leak occurs (which may be detected by pressure), it may be due to someone using a fixture (e.g., a faucet) and not turning it off entirely. This may leave either a slow steady stream of water flowing from the fixture or a drip from the fixture. Therefore, a possible method of determining where a leak may be occurring is to keep track of the water fixtures and devices used and to combine that with knowledge of the system to alert the user as to whether and where a leak may be occurring.

As an example, consider the case where a bathroom faucet is used in a normal manner. At the conclusion of its use, the user turns the faucet to its off position. In a particular example use case, however, a user may not have fully turned the faucet off, resulting in a drip that may not be detected by a flow sensor. The system may have already detected that the bathroom faucet was used, thereby opening the valve, and that the bathroom faucet was turned off, thereby closing the valve.

In this case, because the water is dripping, the pressure will drop, which will open the valve, but a valid flow may not be received, so the valve will be closed. The system may allow this to occur a predetermined number of times, then declare a leak and shut the valve off, which may allow for user intervention to turn it back on, electronically or manually. Because the system may determine that the bathroom faucet was the last device used, e.g., the system may also alert the user to check the bathroom faucet for a possible leak. During the check, the user may recognize that the valve was not fully closed, close it, and reset the system. If the user is not available or home, the system may keep the valve closed, protecting the house/building until a user can check on it and reset it. If it is desired, the user may be able to reset the system remotely. If several fixtures or devices were operating at the same time prior to the leak, the alert can include all of those fixtures or devices. Additionally, the system may be able to list several fixtures or devices that may be leaking based on their time of use, possibly prioritizing the most recently used fixtures or devices.

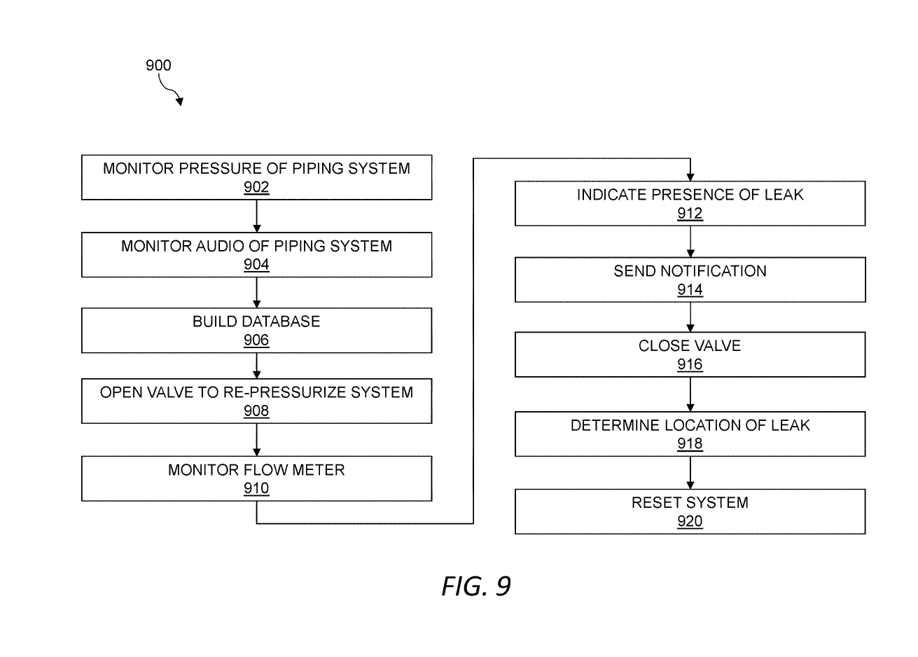

FIG. 9 is a flow chart of a method for locating a leak, in accordance with a representative embodiment.

As shown in box 902, the method 900 may include monitoring a pressure in at least a first location in a piping system.

As shown in box 904, the method 900 may include monitoring audio in at least a second location of the piping system. Audio may be monitored using one or more of the flow sensors as described herein. The first location and the second location may be the same locations, or they may be different locations.

As shown in box 906, the method 900 may include building a historical database of usage of one or more fixtures in the piping system based on at least one of the pressure monitoring and the audio monitoring.

As shown in box 908, the method 900 may include, when a pressure drop is detected but no audio is detected, opening a valve to re-pressurize the piping system.

As shown in box 910, the method 900 may include monitoring a flow meter of the piping system when the valve is open.

As shown in box 912, the method 900 may include, when pressure drops after opening the valve but no audio is detected, and when the flow meter indicates a fluid flow, indicating a presence of a fluid leak.

As shown in box 914, the method 900 may include sending a notification to a user that the presence of the fluid leak is indicated.

As shown in box 916, the method 900 may include, when the presence of the fluid leak is indicated, closing the valve.

As shown in box 918, the method 900 may include using data in the historical database to determine a location of the fluid leak. The data may include a fixture of the of one or more fixtures that was most recently used in the piping system.

As shown in box 920, the method 900 may include resetting a system including processing circuitry for implementing the method 900. For example, this may include a user resetting a computer program product comprising computer executable code embodied in a non-transitory computer readable medium that, when executing on a scanning facility, performs all or part of the method 900.

Determining water flow per node from a single flow meter will now be described.

Such a system may assist in water conservation by tracking and providing data about water usage. The system may have a single flow meter installed, and/or may be using data from a water meter installed by a municipality or the like. This may provide whole house/building data that can assist in spotting trends that indicate excessive water usage and the like. An alert or notification may then be provided to a system user to investigate a cause for possible intervention.

Every water node (e.g., fixtures or devices such as faucets, showers, toilets, bathtubs, washers, and the like) in the system may have an associated water flow sensor that provides water flow detection and an associated amplitude. The amplitude may be an analog value that may be converted to a digital value. In an example system, the amplitude is converted to a digital value between 0 and 255. However, in this example, readings below a certain value of approximately 30 may not be reliable, and therefore may not be considered to be actual flow. By combining data from the single water flow meter and all of the flow sensors, an estimate of the water usage data can be broken down by water usage per node.

Supplying a water flow meter on every node may provide a more accurate representation of water usage per node, but due to component and installation costs this may not be a practical solution. The example method described herein below provides an estimate of water usage per fixture with sufficient accuracy to track water usage trends and alert a user for possible investigation into the cause of any potential issues.

The accuracy can be increased by additional calibration of the equipment. Starting at the lowest accuracy and progressing to the highest possible accuracy, the following calibration techniques may be taken and then used in the calculations. Calibrating the node sensors may include opening the faucet/valve for the node that it is on for an extended time and measuring the acoustic sensor amplitude and water meter readings during the water usage. Some fixtures such as toilets use a fixed amount of water, so calibrating may be done for a single operation of these devices as opposed to using a specified period of time.

Increasing accuracy estimation may include the following: (1) using typical flow rates per fixture (no calibration); (2) calibrating all node sensors individually at a fully open position; (3) calibrating all node sensors individually at various open/close positions; and/or (4) calibrating all node sensors while other node sensors are also activated by water flowing through them.

Additionally, whenever a water flow measurement is done on an individual sensor node for a flow period, the calibration for that node can be updated for greater accuracy. Generally, this update may include an average of the last several readings, and may be used after validating that the data is similar to past data to ensure it is not an anomaly.

The following discussion focuses on estimation method #2 above. However, similar techniques may be used with additional data points for estimation methods #3 and #4 above.

To determine water flow at individual nodes from a single flow meter, several pieces of data may be used to estimate the amount of water flowing through each node. This data may include the flow meter data from an entire system, water detection data from each node, and flow amplitude from each node.

The system described herein may include: a flow meter that measures all water flowing through the system, a sensor at each node that indicates water flow detection, and audio amplitude representing the amount of water flowing through that node.

This method can be described by the following three examples, which are explained below.

1. Single node measurement, which may be the easiest to measure. This may include a single node sensor detecting water flow during a period where the valve is open and the flow meter is capturing readings.

2. Two or more simultaneous nodes measurement. This may include two or more node sensors detecting water flow, where they start detecting water at substantially the same time and stop detecting water flow at substantially the same time. This example may rarely occur in actuality, but is presented to demonstrate allocation techniques.

3. Two or more node sensors asynchronously detecting water flow. This may include a single valve open and close event that detects water flow at two or more nodes. Part of the time a single sensor may be detecting a water flow, and at other times multiple sensors may be detecting water flow. This example may include combining the techniques of the first two examples to estimate water usage.

The following assumptions (based on test data) are made for these examples. Flow rate data for fully open faucet valves was determined on a test system for individual sensors. The test system included a kitchen sink, a bathroom sink, and a toilet. The measured flow rate data in this example case was as follows:

Kitchen faucet=233 ml/s=0.06155 g/s

Bathroom faucet=79 ml/s=0.02087 g/s

Toilet=114 ml/sec (average)=0.03012 g/s

Total toilet water used=6 liters=1.6 gallons (52.5 seconds)

Amplitude data will not be used because these examples focus on water flowing through the fixtures at maximum capacity.

Various flow meters may be used. For those that generate a pulse, the pulses may be recognized and accumulated within the system, which is referred to as the flow meter reading.

### Example 1—Single Node Sensor Measurement

Consider the situation where water is flowing through a single node. This may be the easiest example to calculate because all flow meter data is directly correlated to a single sensor. There is also generally no need to know how long the valve was open. The flow meter may be read at the conclusion of every flow event. For this example, the flow meter reading from before the flow event is subtracted from the flow meter after the flow event.

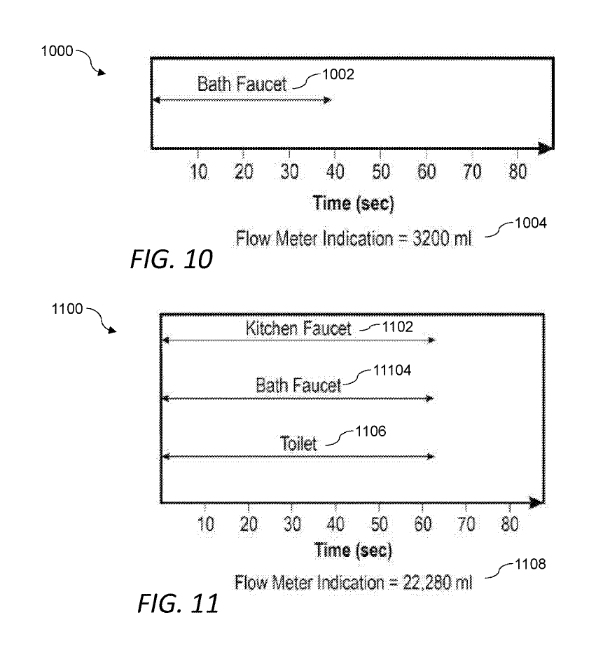

FIG. 10 illustrates a timeline for the usage of a single plumbing fixture, in accordance with a representative embodiment. Specifically, the figure shows a timeline 1000 featuring a time of usage of a bath faucet represented by the first data entry 1002, and a flow meter indication 1004.

In this example, the formula Wb=Wfm is used, where Wb=the water usage of the bathroom faucet, Wfm=the water usage indicated by the flow meter, or Wb=3200 ml as per the example.

### Example 2—Simultaneous Multiple Node Water Usage

Estimating water usage when multiple nodes are supplying water during a single use case may be relatively more complicated. Because the water usage through each node may drop from what was measured at a single node, the characteristics of each node may be accounted for in a final calculation.

As an example, consider the case when a tank toilet is flushed, then a bathroom faucet is turned on, and then a kitchen faucet is turned on. By the end of this event, water supply to all nodes is stopped.

In this example, there are two nodes that have variable water amounts that will flow—the bathroom faucet and the kitchen faucet. The toilet uses the same amount of water to fill the toilet tank, even if the time it takes varies depending on pressure.

FIG. 11 illustrates a timeline for the usage of multiple fixtures, in accordance with a representative embodiment. Specifically, the figure shows a timeline 1100 featuring a time of usage of a kitchen faucet represented by the first data entry 1102, a time of usage of a bath faucet represented by the second data entry 1104, a time of usage of a toilet represented by the third data entry 1106, and a flow meter indication 1108.

As illustrated by the timeline shown in the figure, the following assumptions may be made: the toilet is flushed at time t=0 and stops at 60 seconds; the bathroom faucet is turned on at t=0 and stops at 60 seconds; and the kitchen faucet is turned on at =0 and stops at 62.5 seconds.

If each node was individually supplied water in the above example, it could be calculated that the flows would be as follows:

Kitchen faucet: 233 ml/sec×62.5 sec=14,560 ml;

Bathroom faucet: 79 ml/sec×62.5 sec=4,940 ml;

Toilet: 115 ml/sec×62.5 sec=7,190 ml;

Total calculated water flow (individual nodes)=26,690 ml.

However, total measured flow (22,280 ml) does not match the total calculated flow (26,690 ml). In addition, the toilet fill is 6,000 ml, not 7,190 ml as calculated. The difference may be due to the water being supplied to several nodes simultaneously with less available water pressure and this should be accounted for.

Another estimation may be found by one of the following methods:

(A) Audio Amplitude Estimation—using the amplitude from the audio sensor to scale the calculated flow rate.

(B) Synchronization Estimation—scaling the individual node flow rates to match the total system flow rate.

(C) A combination of using the amplitude and ratio—the Audio Amplitude Estimation method may be optional and only used if the degree of accuracy of converting audio amplitude to flow rate is adequate. The Synchronization Estimation method may provide better estimation results.

Flow Rate Estimation—Audio Amplitude Estimation Method

In order to use the reported amplitude, the amplitude may be calibrated per sensor node. The calibration may include measuring the amplitude that the node and only the node has water flowing through it at full volume, and at least one more data point with water flowing through it at a minimally detectable water flow. This may then be defined as the minimum and maximum values used to interpolate the flow rate. Additional accuracy can be achieved by calibrating and measuring actual flow output at one or more partial flow points.

As an example, assume that a four-point calibration was performed at minimum flow, mid flow, and maximum flow on a bathroom sink and the results were:

| | | |
|---|---|---|
| F1 (Minimum flow): | 30 | 5 ml/min |
| F2 (Low flow): | 50 | 15 ml/min |
| F3 (High flow): | 70 | 65 ml/min |
| F4 (Maximum flow): | 90 | 79 ml/min |

As can be seen from the above example, it is possible to have a non-linear relationship between the audio amplitude and the flow rate. Another estimation may include performing an interpolation between the two closest data points. In the above example, when system reads an audio amplitude of 60, the two closest data points are F2 (15 ml/min) and F3 (65 ml/min), and the interpolated result between these two would be 40 ml/min, as calculated by the formula:

y=y₀+(x−x₀)*(y₁−y₀)/(x₁−x₀)

where:

(x₀, y₀)=(50, 15)−F2 calibration point

(x₁, y₁)=(70, 65)−F3 calibration point

x=60 (measured audio amplitude level)

The remaining nodes could be estimated in a similar manner. If this estimation is performed, the estimation by Synchronization Estimation method may also be performed prior to finalizing to synchronize the node flow totals to the entire system total.

Flow Rate Estimation—Synchronization Estimation Method #1

This method may assume that some nodes have known water usages (such as the toilet) per use, and that the remainder can be calculated by scaling the ratios of the remaining nodes. This may therefore be a generic synchronization method.

The example totals repeated are:

Kitchen faucet: 233 ml/sec×62.5 sec=14,560 ml

Bathroom faucet: 79 ml/sec×62.5 sec=4,940 ml

Toilet: 115 ml/sec×62.5 sec=7,190 ml

Total calculated water flow (individual nodes)=26,690 ml

The actual flow meter reading total indicated 22,280 ml (difference was due to water supplying several nodes and nodes were calibrated in an isolated environment).

The toilet fill water usage=6000 ml. The remaining water usage, 16,280 ml can be allocated to the sink faucet and kitchen faucet.

If it is assumed that the ratio of lowered water usage is equal upon all nodes, the remaining water usage can be scaled using the ratios of what would have been used in an isolated node usage.

The following calculations demonstrate the scaling:

Water usage left to allocate to bathroom faucet and kitchen faucet: 22,280 ml−6000 ml=16,280 ml.

Single node water usage—Toilet: 6000 ml (known water usage per use)

Single node water usage—Kitchen Faucet. Calculating kitchen faucet percentage: (kitchen calculated flow)/(total calculated flow)−(known single use flow calculation (toilet))=14,560 ml/(26,690 ml−7190)=74.7%

Kitchen faucet usage—(Actual reading−known single use flow)*Kitchen faucet %=16,280 ml×0.747=12,161 ml

Single node water usage—Bathroom Faucet. Calculating bathroom faucet percentage: (bathroom calculated flow)/(total calculated flow)−(known single use flow calculation (toilet))=4,940 ml/(26,690 ml−7190 ml)=25.3%

Bathroom faucet usage—(Actual reading−known single use flow)*bathroom faucet %=16,280×0.253=4119 ml

TOTAL estimated per node=6000+12,161+4,119=22,280 (matches actual measurement)

Flow Rate Estimation—Synchronization Estimation Method #2

This method may include that one of the nodes be a known water usage per use device, such as a toilet. The example totals repeated are:

Kitchen faucet: 233 ml/sec×62.5 sec=14,560 ml

Bathroom faucet: 79 ml/sec×62.5 sec=4,938 ml

Toilet: 115 ml/sec×62.5 sec=7,190 ml

Total calculated water flow (individual nodes)=26,690 ml

The actual flow meter reading total indicated 22,280 ml (difference was due to water supplying several nodes and nodes were calibrated in an isolated environment).

The toilet fill water usage=6000 ml. The calculated amount is 7,190 ml. The actual toilet water usage is 83.45% of the calculated total. If this ratio is applied to all nodes:

Toilet=7190 ml*0.8345=6000 ml

Kitchen faucet=14,560 ml*0.8345=12,150 ml

Bathroom faucet=4,940 ml*0.8345=4120 ml

Total=22,270 ml (10 ml difference in actual due to rounding errors)

The rounding errors could be added to a single node, or allocated across the nodes to fully synchronize the individual node data to the total.

The estimation methods produce similar results, for which errors may be negligible in practical use.

### Example 3—Simultaneous Multiple Node Water Usage Mixed with Individual Node Flows

The example provided in the simultaneous multiple node water usage use case may rarely happen in actuality. In most cases, the water usage will be either a single node usage or multiple nodes starting and stopping during a time period, where at times they will simulate a single node water event and at other times they will simulate a multiple node water event.

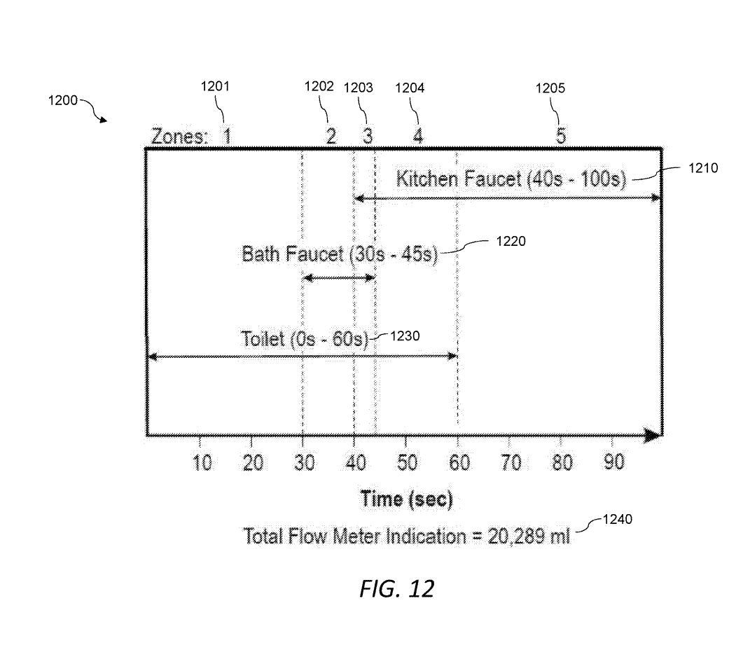

FIG. 12 illustrates a timeline for the usage of multiple fixtures, in accordance with a representative embodiment. Specifically, the figure shows a timeline 1200 featuring a number of zones—a first zone 1201, a second zone 1202, a third zone 1203, a fourth zone 1204, and a fifth zone 1205. The timeline 1200 includes the time of usage of a kitchen faucet represented by the first data entry 1210, a time of usage of a bath faucet represented by the second data entry 1220, a time of usage of a toilet represented by the third data entry 1230, and a flow meter indication 1240.

Take for example the case shown in the figure where the toilet is flushed, then the bathroom faucet comes on, then the kitchen sink comes on, and each turns off at different times.

Flow meter indications by zone are as follows in the example:

Zone 1—3420 ml

Zone 2—1610 ml

Zone 3—1598 ml

Zone 4—4341 ml

Zone 5—9320 ml

As indicated in the chart shown in the figure, an event such as this can be broken down in several distinct zones. These zones may include individual node flows and multiple node flows. The water usage estimations can be broken down into individual zones. The specific calculations may be the same as for the individual node flows, and multiple node flows.

In the example, Zone 1 is a time period where only the toilet is flowing. The individual node calculation can be used for this zone.

In the example, Zone 2 is a two-node event where the toilet and sink faucet is using water. The multi-node estimation can be used for this zone. The toilet should be considered in the estimation as a normal flowing device as opposed to a fixed use device since its fill is spread over several zones.

In the example, Zone 3 is a three-node event with the toilet, sink faucet, and kitchen faucet all using water. The multi-node calculation can be used with all devices being considered normal flow devices for this zone.

In the example, Zone 4 is a two-node event, with the toilet and kitchen faucet using water. The multi-node calculation can be used with all devices being considered normal flow devices for this zone.

In the example, Zone 5 is a time period where only the kitchen faucet was flowing. The individual node calculation can be used for this zone.

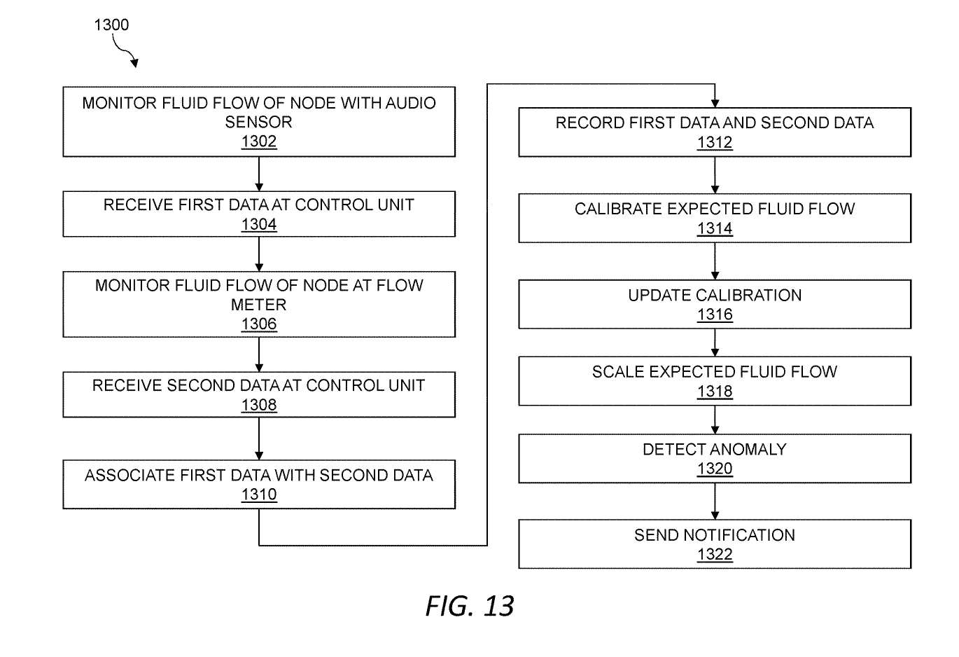

FIG. 13 is a flow chart of a method of determining fluid flow in a piping system. The fluid flow may be determined using one or more flow sensors as described herein, e.g., a flow sensor disposed at one or more nodes in a piping system (e.g., at each node), and one or more flow meters, e.g., a single flow meter for the piping system.

As shown in box 1302, the method 1300 may include monitoring fluid flow using an audio sensor for each of a number of nodes in a piping system. The number of nodes may include one or more of a faucet, a shower, a toilet, a bathtub, a washing machine, a dishwasher, a range, an oven, a grill, a fireplace, a sprinkler system, an irrigation system, and so on. The piping system may be the entire piping system of a home, or part of a home's piping system.

As shown in box 1304, the method 1300 may include receiving first data regarding audio detected by the audio sensor for at least one of the number of nodes at a control unit that includes a processor and a memory. The first data may include one or more of: (i) a binary flow detection based on the audio of one of the number of nodes (e.g., a flow ON condition and a flow OFF condition), and (ii) an audio amplitude based on the audio representing an amount of fluid flow for the use of one of the number of nodes.

As shown in box 1306, the method 1300 may include monitoring fluid flow by detecting fluid usage at a flow meter for the piping system. The flow meter may be the main flow meter for an entire piping system, e.g., a municipality flow meter.

As shown in box 1308, the method 1300 may include receiving second data regarding the fluid usage at the control unit.

As shown in box 1310, the method 1300 may include associating the second data with the first data at the control unit thereby associating an expected fluid flow with a use of at least one of the number of nodes.

As shown in box 1312, the method 1300 may include recording the first data and the second data to establish a historical database of fluid flows.

As shown in box 1314, the method 1300 may include calibrating the expected fluid flow of one of the number of nodes by activating a node for a predetermined time period or operation, and measuring one or more of audio amplitude detected by the audio sensor and a fluid usage reading at the flow meter. The node may be activated at a fully open position for calibration. In implementations, a plurality of nodes is activated at the same time for calibration of a zone comprising the plurality of nodes.

As shown in box 1316, the method 1300 may include updating a calibration for at least one of the nodes based on one or more of audio amplitude detected by the audio sensor and a fluid usage reading at the flow meter during use of the nodes. In implementations, updating the calibration for the nodes uses an average of a number of uses of the nodes.

As shown in box 1318, the method 1300 may include using an audio amplitude detected by the audio sensor to scale the expected fluid flow. In implementations, the method 1300 may also or instead include scaling the expected fluid flow to match a total measured fluid flow for the piping system.

As shown in box 1320, the method 1300 may include detecting an anomaly in a detected fluid flow based on a comparison of the detected fluid flow with information in the historical database of fluid flows.

As shown in box 1322, the method 1300 may include sending a notification to a user when the anomaly is detected.

An implementation may include a passive device for detecting fluid flow in a pipe, including a housing, a mechanical couple structurally configured for attaching the housing to at least one of a pipe and a structure disposed in close proximity to the pipe, and a chamber disposed within the housing such that the chamber is physically isolated from the pipe, the chamber sized and shaped to receive a sound wave at a first end thereof and to amplify the sound wave between the first end and a second end of the chamber, the sound wave including a frequency range corresponding to that of a predetermined fluid flowing through an interior of the pipe. The passive device may also include a sensor disposed at the second end of the chamber to receive the sound wave amplified by the chamber, and communications circuitry configured to send a signal corresponding to the sound wave received by the sensor to an external computing device.

Implementations may include one or more of the following features. The passive device further including a processor configured to perform one or more of filtering and further amplification of the sound wave received by the sensor prior to the communications circuitry sending the signal to the external computing device. The passive device where the processor performs filtering, and where the filtering includes removing one or more unwanted frequencies from the sound wave received by the sensor. The passive device where the processor performs further amplification of the sound, and where the further amplification includes amplifying a target frequency included in the sound wave received by the sensor. The passive device where the target frequency is about 1750 hertz. The passive device where the processor is further configured to determine if the sound wave received by the sensor is above a threshold value for confirmed fluid flow. The passive device where the signal includes an indication of fluid flow in the pipe when the sound wave received by the sensor is above the threshold value. The passive device where the threshold value is a dynamic threshold value. The passive device where the sensor includes a first microphone. The passive device further including a noise canceling device. The passive device where the noise canceling device includes a second microphone that sends an audio signal to a processor, the audio signal corresponding to external noise detected by the second microphone, the processor configured to filter the external noise from the sound wave received by the sensor prior to the communications circuitry sending the signal corresponding to the sound wave. The passive device where the chamber includes a substantially tubular shape. The passive device where the substantially tubular shape is substantially straight between the first end and the second end of the chamber. The passive device where the substantially tubular shape includes a curve between the first end and the second end of the chamber. The passive device where the substantially tubular shape is a cylinder. The passive device where the chamber is mechanically configured to be tunable for a number of frequency ranges by adjusting one or more of a size and a shape of the chamber. The passive device where the predetermined fluid is water. The passive device where the frequency range of the sound wave is about 1500 hertz to about 2000 hertz. The passive device where the frequency range includes a target frequency of about 1750 hertz. The passive device where the predetermined fluid is natural gas. The passive device where the chamber is open on the first end and closed on the second end. The passive device where the signal corresponding to the sound wave is wirelessly transmitted through a network. The passive device where the network includes one or more of Z-Wave, Wi-Fi, ZigBee, and Bluetooth. The passive device where the external computing device is coupled to the network, and where the external computing device includes one or more of a smartphone, a tablet, a personal computer, a small form factor computer, a wearable computer, and a home automation device. The passive device where the external computing device includes a small form factor computer, and where the small form factor computer is configured to process data from the sensor. The passive device where the external computing device includes a smartphone, the smartphone including a user interface and a communications interface. The passive device where the smartphone includes a processor configured to determine whether fluid flow is present in the pipe from the signal. The passive device where the communications interface of the smartphone is configured to receive a notification regarding fluid flow in the pipe. The passive device where the signal corresponding to the sound wave includes an indication of fluid flow in the pipe. The passive device where the signal corresponding to the sound wave includes amplitude information. The passive device further including a power source. The passive device where the power source includes a battery. The passive device where the power source includes a direct current (DC) input. The passive device where the mechanical couple includes a clamp for attaching the housing to an exterior of the pipe. The passive device where the mechanical couple includes an adhesive for attaching the housing to a wall, where the pipe is disposed behind the wall. The passive device where the housing includes a base portion engaged with the mechanical couple, where the chamber is disposed within the housing with the first end directed toward the base portion.

An implementation may include a method for detecting fluid flow in a pipe, including receiving a sound wave caused by fluid flow in a pipe at a first end of a chamber that is physically isolated from the pipe, the chamber sized and shaped to amplify the sound wave between the first end and a second end of the chamber, the sound wave including a frequency range corresponding to that of a predetermined fluid flowing through an interior of the pipe. The method may also include receiving the sound wave amplified by the chamber at a sensor disposed at the second end of the chamber, receiving a first signal corresponding to the sound wave received by the sensor at a processor, and processing, with the processor, the first signal by performing one or more of filtering and further amplification of the sound wave received by the sensor. The method may also include determining, with the processor, whether the sound wave received by the sensor is above a dynamic threshold value for confirmed fluid flow by analyzing the processed first signal. The method may also include transmitting, using communications circuitry coupled to the processor, a second signal including an indication of fluid flow in the pipe to an external computing device when the sound wave received by the sensor is above the threshold value.

Another implementation may include a method for determining fluid flow or leaks of a piping system from an acoustic signal, including receiving a sound wave external to a pipe at a first end of a chamber that is physically isolated from the pipe, providing noise isolation within the chamber, and detecting audio by a sensor disposed in a second end of the chamber, where audio is detected only if above a first minimum threshold for the sensor, the first minimum threshold selected to detect fluid flow based on a predetermined frequency corresponding to that of a predetermined fluid flowing through an interior of the pipe. The method may also include monitoring for detected audio to drop below a second minimum threshold for a stoppage of fluid flow, and indicating fluid flow only when the detected audio occurs for a minimum time period before dropping below the second minimum threshold, the minimum time period selected to indicate fluid flow. The method may also include monitoring for impulse detections based on detected audio below the minimum time period, determining whether an impulse is periodic, and sending an alert when the impulse is periodic thereby inferring a leak.

Implementations may include one or more of the following features. The method may also include indicating that the impulse is noise when the impulse is not periodic. The method where providing noise isolation includes canceling ambient noise from being received by the sensor. The method where the sensor includes a microphone. The method where canceling ambient noise is provided by a second microphone disposed in the chamber that electronically cancels noise that is common to both microphones. The method where canceling ambient noise is passively provided by a shape of the chamber. The method where the shape of the chamber is configured to sum interference of an unwanted noise signal and its reflection for presentation to the sensor. The method where providing noise isolation includes positioning the sensor away from noise sources external to the pipe and reflections thereof. The method where providing noise isolation includes providing acoustic foam that dampens unwanted noise sources. The method where providing noise isolation includes baffling to attenuate unwanted noise. The method where the predetermined frequency is selected to distinguish background noise from fluid flow. The method where the first minimum threshold and the second minimum threshold are different values. The method where the first minimum threshold is greater than the second minimum threshold. The method where the first minimum threshold and the second minimum threshold are the same. The method where the minimum time period is at least one second. The method where the alert is sent to an external computing device of a user.

An implementation may include a method for locating a leak, including monitoring a pressure in at least a first location in a piping system, monitoring audio in at least a second location of the piping system, and, when a pressure drop is detected but no audio is detected, opening a valve to re-pressurize the piping system. The method may also include monitoring a flow meter of the piping system when the valve is open. The method may also include, when pressure drops after opening the valve but no audio is detected, and when the flow meter indicates a fluid flow, indicating a presence of a fluid leak. The method may also include, when the presence of the fluid leak is indicated, closing the valve.

Implementations may include one or more of the following features. The method further including sending a notification to a user that the presence of the fluid leak is indicated. The method further including building a historical database of usage of one or more fixtures in the piping system based on at least one of the pressure monitoring and the audio monitoring. The method further including using data in the historical database to determine a location of the fluid leak. The method where the data includes a fixture of the of one or more fixtures that was most recently used in the piping system. The method further including resetting a system including processing circuitry for implementing the method.

An implementation may include a method of determining fluid flow in a piping system, including monitoring fluid flow using an audio sensor for each of a number of nodes in a piping system, receiving first data regarding audio detected by the audio sensor for at least one of the number of nodes at a control unit including a processor and a memory, monitoring fluid flow by detecting fluid usage at a flow meter for the piping system, receiving second data regarding the fluid usage at the control unit, and associating the second data with the first data at the control unit thereby associating an expected fluid flow with a use of the at least one of the number of nodes.

Implementations may include one or more of the following features. The method further including recording the first data and the second data to establish a historical database of fluid flows. The method further including detecting an anomaly in a detected fluid flow based on a comparison of the detected fluid flow with information in the historical database of fluid flows. The method further including sending a notification to a user when the anomaly is detected. The method where the first data includes one or more of: (i) a binary flow detection based on the audio of the at least one of the number of nodes, and (ii) an audio amplitude based on the audio representing an amount of fluid flow for the use of the at least one of the number of nodes. The method further including calibrating the expected fluid flow of one of the number of nodes by activating the one of the number of nodes for a predetermined time period or operation, and measuring one or more of audio amplitude detected by the audio sensor and a fluid usage reading at the flow meter. The method where the one of the number of nodes is activated at a fully open position for calibration. The method where a plurality of the number of nodes are activated at the same time for calibration of a zone including the plurality of the number of nodes. The method further including updating a calibration for at least one of the number of nodes based on one or more of audio amplitude detected by the audio sensor and a fluid usage reading at the flow meter during use of the at least one of the number of nodes. The method where updating the calibration for the at least one of the number of nodes uses an average of a number of uses of the at least one of the number of nodes. The method further including using an audio amplitude detected by the audio sensor to scale the expected fluid flow. The method further including scaling the expected fluid flow to match a total measured fluid flow for the piping system. The method where the number of nodes includes one or more of a faucet, a shower, a toilet, a bathtub, a washing machine, and a dishwasher.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another implementation, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another implementation, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another implementation, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of this disclosure and are intended to form a part of the disclosure as defined by the following claims, which are to be interpreted in the broadest sense allowable by law.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A passive device for detecting fluid flow in a pipe, comprising:
a housing;
a mechanical couple structurally configured for attaching the housing to at least one of a pipe and a structure disposed in close proximity to the pipe;
a chamber disposed within the housing such that the chamber is physically isolated from the pipe, the chamber sized and shaped to receive a sound wave at a first end thereof and to amplify the sound wave between the first end and a second end of the chamber, the sound wave comprising a frequency range corresponding to that of a predetermined fluid flowing through an interior of the pipe;
a sensor disposed at the second end of the chamber to receive the sound wave amplified by the chamber; and
communications circuitry configured to send a signal corresponding to the sound wave received by the sensor to an external computing device.

2. The passive device of claim 1, further comprising a processor configured to perform one or more of filtering and further amplification of the sound wave received by the sensor prior to the communications circuitry sending the signal to the external computing device.

3. The passive device of claim 2, where the processor performs filtering, and where the filtering comprises removing one or more unwanted frequencies from the sound wave received by the sensor.

4. The passive device of claim 2, where the processor performs further amplification of the sound, and where the further amplification comprises amplifying a target frequency included in the sound wave received by the sensor.

5. The passive device of claim 2, where the processor is further configured to determine if the sound wave received by the sensor is above a threshold value for confirmed fluid flow.

6. The passive device of claim 5, where the signal comprises an indication of fluid flow in the pipe when the sound wave received by the sensor is above the threshold value.

7. The passive device of claim 1, where the sensor comprises a microphone.

8. The passive device of claim 1, further comprising a noise canceling device.

9. The passive device of claim 8, where the noise canceling device comprises a microphone that sends an audio signal to a processor, the audio signal corresponding to external noise detected by the microphone, the processor configured to filter the external noise from the sound wave received by the sensor prior to the communications circuitry sending the signal corresponding to the sound wave.

10. The passive device of claim 1, where the chamber comprises a substantially tubular shape.

11. The passive device of claim 10, where the substantially tubular shape is substantially straight between the first end and the second end of the chamber.

12. The passive device of claim 10, where the substantially tubular shape comprises a curve between the first end and the second end of the chamber.

13. The passive device of claim 1, where the chamber is mechanically configured to be tunable for a number of frequency ranges by adjusting one or more of a size and a shape of the chamber.

14. The passive device of claim 1, where the predetermined fluid is one or more of water and natural gas.

15. The passive device of claim 14, where the predetermined fluid is water, and where the frequency range of the sound wave is about 1500 Hertz to about 2000 Hertz.

16. The passive device of claim 1, where the chamber is open on the first end and closed on the second end.

17. The passive device of claim 1, where the signal corresponding to the sound wave is wirelessly transmitted through a network, where the external computing device is coupled to the network, and where the external computing device comprises one or more of a smartphone, a tablet, a personal computer, a small form factor computer, a wearable computer, and a home automation device.

18. The passive device of claim 17, where the external computing device comprises a smartphone, the smartphone comprising a user interface and a communications interface.

19. The passive device of claim 18, where the smartphone comprises a processor configured to determine whether fluid flow is present in the pipe from the signal.

20. The passive device of claim 18, where the communications interface of the smartphone is configured to receive a notification regarding fluid flow in the pipe.

21. The passive device of claim 1, where the signal corresponding to the sound wave comprises one or more of an indication of fluid flow in the pipe and amplitude information.

22. The passive device of claim 1, where the mechanical couple comprises a clamp for attaching the housing to an exterior of the pipe.

23. The passive device of claim 1, where the mechanical couple comprises an adhesive for attaching the housing to a wall, where the pipe is disposed behind the wall.

24. The passive device of claim 1, where the housing comprises a base portion engaged with the mechanical couple, where the chamber is disposed within the housing with the first end directed toward the base portion.

25. A method for detecting fluid flow in a pipe, comprising:
receiving a sound wave caused by fluid flow in a pipe at a first end of a chamber that is physically isolated from the pipe, the chamber sized and shaped to amplify the sound wave between the first end and a second end of the chamber, the sound wave comprising a frequency range corresponding to that of a predetermined fluid flowing through an interior of the pipe;
receiving the sound wave amplified by the chamber at a sensor disposed at the second end of the chamber;
receiving a first signal corresponding to the sound wave received by the sensor at a processor;
processing, with the processor, the first signal by performing one or more of filtering and further amplification of the sound wave received by the sensor;
determining, with the processor, whether the sound wave received by the sensor is above a dynamic threshold value for confirmed fluid flow by analyzing the processed first signal; and
transmitting, using communications circuitry coupled to the processor, a second signal comprising an indication of fluid flow in the pipe to an external computing device when the sound wave received by the sensor is above the threshold value.
